(19) United States
(12) Patent Application Publication
(10) Pub. No.: US 2014/0317408 A1
(43) Pub. Date: Oct. 23, 2014

(54) DATA BACKUP AND SERVICE ENCRYPTION KEY MANAGEMENT

(71) Applicant: KASEYA INTERNATIONAL LIMITED, St. Helier (JE)

(72) Inventor: George Runcie, San Jose, CA (US)

(73) Assignee: Kaseya International Limited, St. Helier (JE)

(21) Appl. No.: 13/866,112

(22) Filed: Apr. 19, 2013

(51) Int. Cl. H04L 9/08

(52) U.S. Cl. CPC H04L 9/0819
USPC 713/171

(57) ABSTRACT

Disclosed are an apparatus and method of using encryption to access remote online application servers. One example method of operation may include applying an encryption key to an application server access operation. The method may include transmitting authentication credentials to an encryption server and receiving an application session key from the encryption server. The session key is then applied to an agent application seeking access to an application server. The method may also provide transmitting the session key in an encryption request to the encryption server to obtain an encryption key, and receiving an encryption key responsive to the transmitted session key.

### TECHNICAL FIELD OF THE APPLICATION

This application relates to a method and apparatus of managing the encryption key functions performed between client computing system, data backup servers and other related network communication services.

### BACKGROUND OF THE APPLICATION

Conventionally, in order to provide a layer of protection for user data, an application operating on the client computing device may initiate an encryption algorithm or generate an encryption key to protect the data from unauthorized access.

The encryption key may be based on privileged information that is not readily accessible by other entities operating under the same communication network. For example, encryption keys may be derived from user information (e.g., passwords, computer names, user names, etc.) and when another device is seeking access to the encrypted data, those encryption keys may not be readily accessible for decryption purposes.

### SUMMARY OF THE APPLICATION

One embodiment of the present application may include a method that provides transmitting authentication credentials to an encryption server, receiving an application session key from the encryption server, applying the session key to an agent application seeking access to an application server, transmitting the session key in an encryption request to the encryption server to obtain an encryption key, and receiving an encryption key responsive to the transmitted session key.

Another example embodiment may include an apparatus including a transmitter configured to transmit authentication credentials to an encryption server and a receiver configured to receive an application session key from the encryption server. The apparatus may also include a processor configured to apply the session key to an agent application seeking access to the application server, and the transmitter is also configured to transmit the session key in an encryption request to the encryption server to obtain an encryption key, and receive an encryption key responsive to the transmitted session key.

### BRIEF DESCRIPTION OF THE DRAWINGS

FIG. 1 illustrates an example network architecture of a client computing device accessing remote application cloud servers with an encryption service provided by an encryption server according to example embodiments of the present application.

FIG. 2 illustrates an example communication signaling system diagram of an encryption key setup and data sharing procedure according to example embodiments of the present application.

FIG. 3 illustrates another example communication signaling system diagram of an encryption key setup and data sharing procedure according to example embodiments of the present application.

FIG. 4 illustrates a flow diagram of an example method according to an example embodiment of the present application.

FIG. 5 illustrates a system configuration that is configured to perform one or more operations corresponding to the example embodiments.

FIG. 6 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments of the present disclosure provide online backup access to client devices operating in a distributed network infrastructure, such as an enterprise network or large-scale resource network. In operation, a client computing device may be operating as a client on a client/server application model. During an agent installation operation, a request may be transmitted to a billing service (BIS) to ‘install’ the agent application.

The BIS will process the request and create a new ‘versioned’ data encryption key required for subsequent data encrypting. BIS will manage the data encryption key going forward. The agent installation success is dependent on the BIS agent installation. BIS will use HTTPS for secure communication. The virtual systems administrator (VSA) may utilize an installation partition key. The partition key may be outdated and require an update.

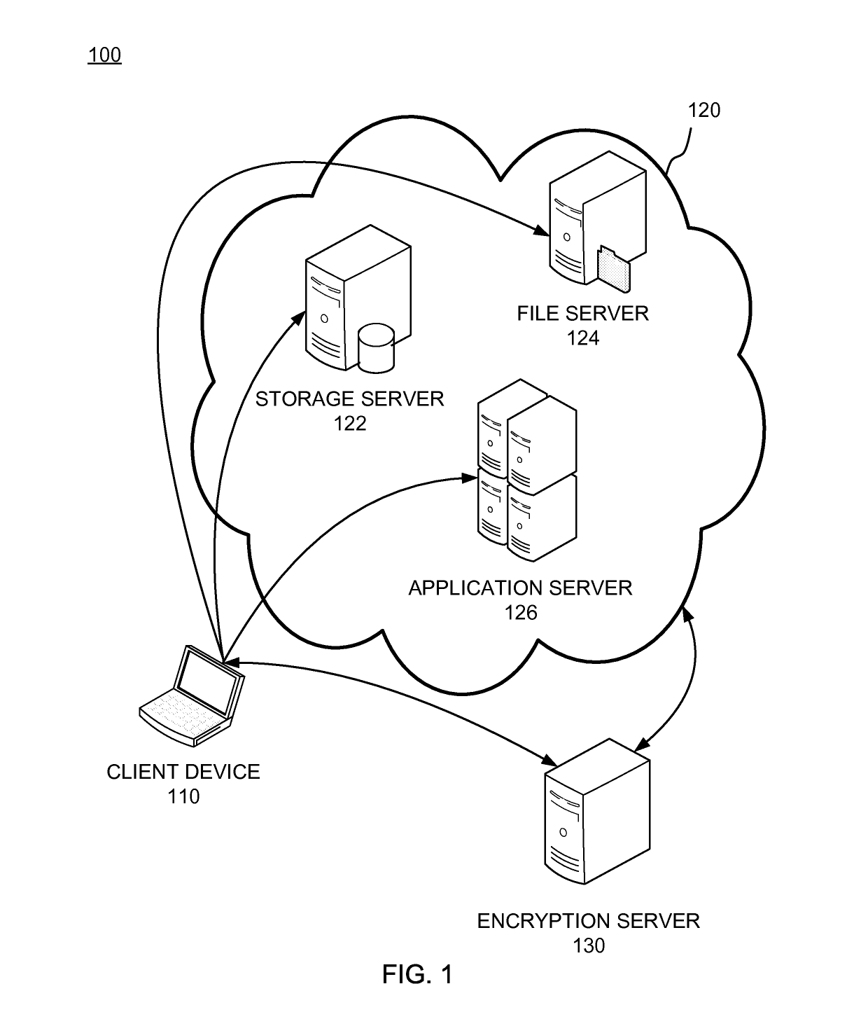

FIG. 1 illustrates an example network architecture of a client computing device accessing remote application cloud servers with an encryption service provided by an encryption server according to example embodiments of the present application. Referring to FIG. 1, a client device 110 may be operating in a data network 100 and may be seeking access to various cloud resources 120, such as a data storage server 122, an application server 126 and a file server 124. The encryption server 130 may be required to provide the user with the proper encryption key in order to be authorized by the various cloud servers 120.

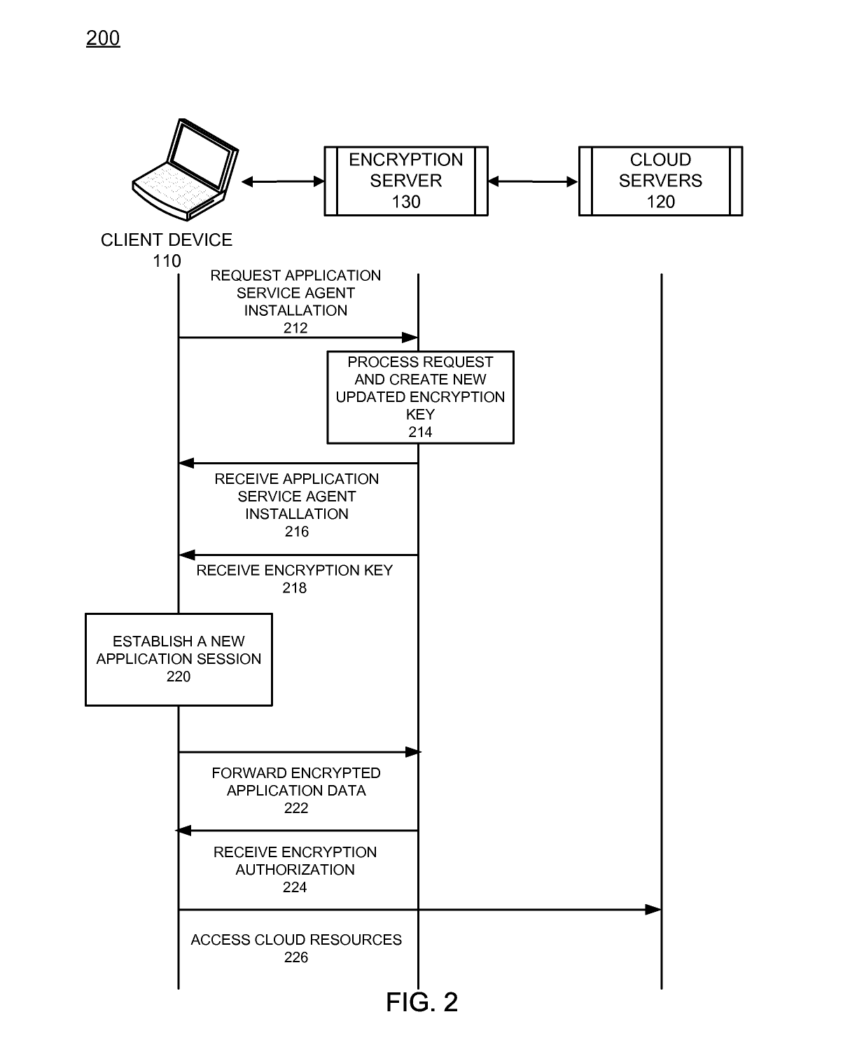

FIG. 2 illustrates an example communication signaling system diagram of an encryption key setup and data sharing procedure according to example embodiments of the present application. Referring to FIG. 2, the client device 110 may be accessing the cloud servers 120 by first establishing a communication sequence with the encryption server 130 to be authorized prior to accessing the cloud resources 120.

In operation, the client device 110 may request an application service agent plug-in 212, application or portal be installed on the client device to access the encryption server 130. The request may be processed and a new updated encryption key 214 may be generated responsive to the service agent installation process or in response to a request for an updated key. The agent application software 216, and subsequently or contemporaneously, an encryption key may be transmitted 218 from the encryption server 130 to the client device 110. Next, the client device 110 may establish a new application session 220 in order to apply the encryption key and access remote resources. The encryption key may be applied to application data shared or transmitted 220 to and from the client device 110. The encrypted application data may be transmitted to the encryption server 222 to identify the client device 110 prior to accessing remote resources. The encryption authorization message may be received 224 at the client device 110 prior to the client device accessing cloud resources 226.

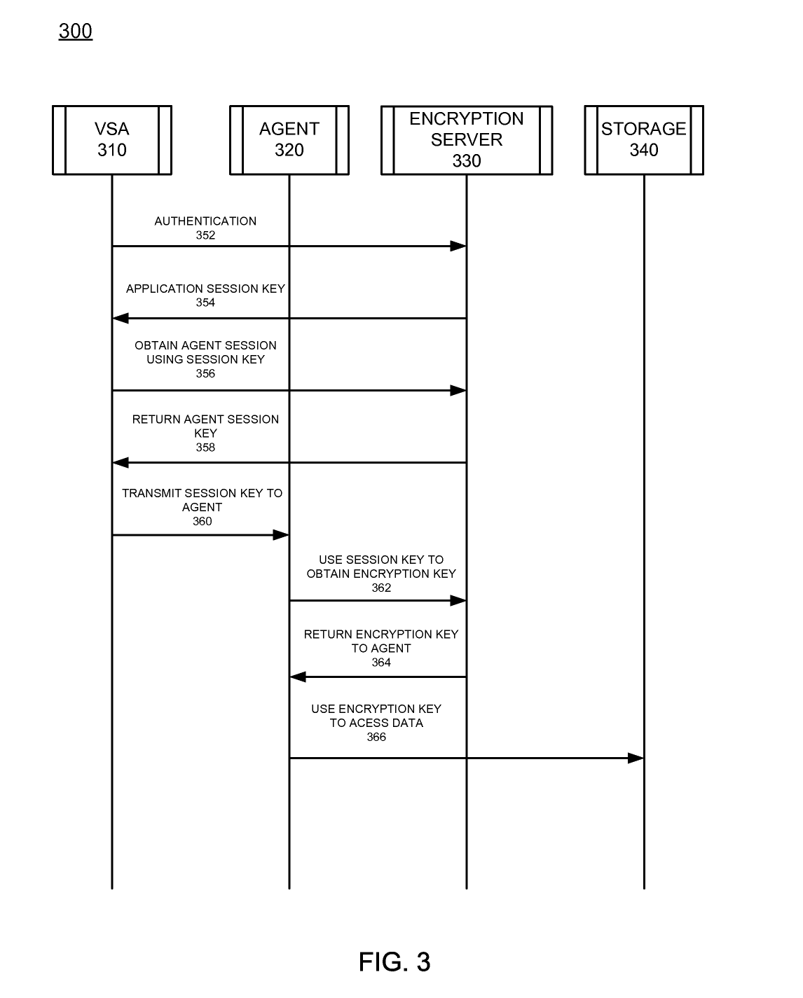

FIG. 3 illustrates another example communication signaling system diagram of an encryption key setup and data sharing procedure according to example embodiments of the present application. Referring to FIG. 3, the network 300 includes four main entities, including a virtual systems administrator (VSA) 310, an agent application operating device 320, an encryption server and a storage server 340. The VSA 310 and the agent 320 may be operating as the same entity or as a pair of entities working in unison to satisfy the requirements of the encryption server 330 in order to obtain access to the storage server 340 or other application server.

Initially, the VSA 310 may transmit an authentication request or credentials 352 to the encryption server 330. In response, the VSA 310 may receive an application session key 354 for the current session. The agent session setup request may then be transmitted 356 from the VSA 310 to the encryption server 330. In response, the encryption server 330 may return an agent session key 358 to the VSA 310, which transmits a session key 360 to the agent 320 so the agent may initiate an application access operation or other related function. The agent 320 may then use the session key to obtain an encryption key 362 by transmitting the session key to the encryption server 330. As a result, the encryption server 330 may authorize the session key and return an encryption 364 key to the agent application of the corresponding device seeking authorization. Finally, the encryption key may be applied to the agent application 320 to obtain access to remote resources 366, such as the storage server 340.

An example application programming interface (API) may include—Request (REST:POST):
URI—
Stem: ˜/handlers/BillingService/InstallAgent.ashxConten t-Type: application/json
Body:
partition_key: <pre-generated installation partition key>
agent_guid: <agent guid>
application_id: kob
agent_displayname: <agent display name>
Response:
   200—OK
   400—Bad Request
   401—Unauthorized—invalid partition key
   500—Operation failed due to a server error
   503—Service Unavailable
   No Body.

During agent uninstall, a request may be transmitted to the billing service (BIS) to ‘uninstall’ the agent. The application may use a service to request that the agent BIS uninstall be performed during an agent uninstall. BIS will process the request and remove the agent from the BIS management cycle. An agent uninstall success is dependent on BIS agent uninstall. BIS will use HTTPS for secure communication.

A monitor service may request agent session keys prior or during agent backup or restore script execution. BIS will process the request and create a new ‘one time use’ temporary session key per request. After receiving a successful response, the monitor service will scramble the BIS session key using CRC32. The monitor service will make the scrambled BIS session key available for script consumption by storing the key. Backups or restores will use BIS session keys to retrieve data encryption keys and S3 credentials.

Scripts for both backup and restore will read the BIS agent session key and store it in a script variable: ‘bisSessionKey’. BIS key is guaranteed to exist, otherwise the script will fail and it will log an error message. Scripts will pass ‘bisSessionKey’ to OnlineBackupService via ‘SendMessage’ script command. Scripts will remove BIS session key from kobAgentSettings\bisSessionKey using agent and a BIS session key value and may only remove an entry from the kobAgentSettings table if the BIS session key value matches the script variable ‘bisSessionKey’.

In operation, an ‘OnlineBackupService’ will unscramble a billing service session key using CRC32. The OnlineBackupService will use the BIS service to retrieve the agent's data encryption key, S3 credentials and a new BIS session key using the unscrambled BIS session key. A request will be performed during the OnlineBackupService's ‘BackupProcessor’ initialization. Request for the data encryption key and S3 credentials will also include versioning allowing for key recycling, and each key request will indicate which version to retrieve. For example, on file backup, the latest data encryption key version will be requested. On file backup, a new S3 object metadata will store a data encryption key version number.

On file restore, all data encryption key versions will be requested, the S3 object metadata will indicate which key version use to decrypt object data. Both backup and restore operations will request a S3 access key ID, S3 secret access key and a S3 namespace ID. Both backup and restore operations will request a new BIS session key.

A new BIS session key will be used to post account usage. The API may provide:
Request (REST:POST):
URI-Stem: ˜/handlers/BillingService/GetKeys.ashx
Content-Type: application/json
Body (JSON encoded): session_key <session key>
keyname_list: <key version list> comma separated pairs of keyname@version list.
Example:
s3AccessKeyId@1,s3SecretAccessKey@1,s3NameSpaceId@1,kobData
Encryption@1
Response: 200—OK
   400—Bad Request
   401—Unauthorized—invalid session key
   500—Operation failed due to a server error
   503—Service Unavailable
   Content-Type: application/json
Body (JSON encoded): keyname_list: <key list> comma separated pairs of keyname@version=value list.
Each value is alphanumeric, and may not contain characters such as, @ or =.
Example: s3AccessKeyId@1=BKIAJNKSRGB7BUYNQ,s3SecretAccessKe y@1=81G3u30Q0CKvQd4kGHi4y5kGlPSo7qeH7EnE,s3NameSpaceId@1=KA SEYAKOB2,kobDataEncryption@1=JHWIUHDFKJHA9844
session_key <new session key>.

KOB Agent OnlineBackupService dll will use the billing service (BIS) session key to post agent S3 usage. After backup or restore completion, ‘OnlineBackupService’ dll will post S3 usage to BIS using a BIS REST service. The following usage values will be posted to BIS:
OperationType=<Backup|Restore|Delete>
FinishUTCTime
FinishDate
TotalCompressedBytes
TotalUncompressedBytes
TotalTransferBytes
BIS will use HTTPS, securing communication between agent (OnlineBackupService) and BIS.
An example API may provide:
Request (REST:POST):
URI-Stem: ˜/handlers/BillingService/PostUsage.ashx
Content-Type: application/json
Body:
session_key <session key>
service_name: kob
usage_values: <value list> comma separated name=value list.
Example: TotalTransferBytes=32155,TotalBackupCompressedByte s=216554 . . .
   Response:
   200—OK
   400—Bad Request
   401—Unauthorized—invalid session key
   500—Operation failed due to a server error
   503—Service Unavailable.

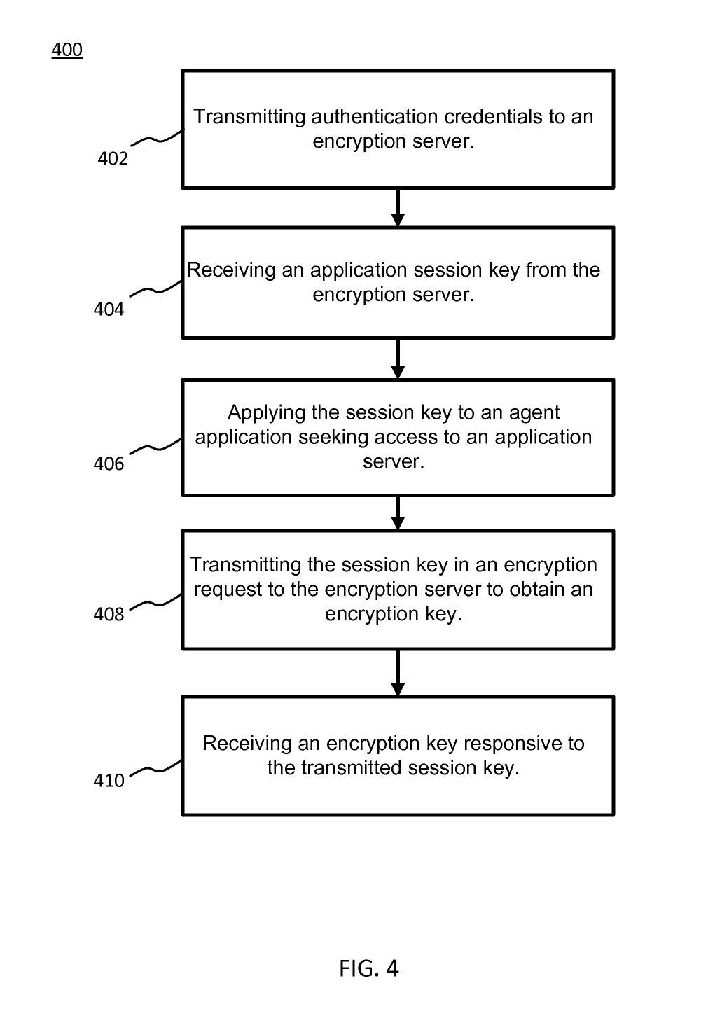

FIG. 4 illustrates an example method flow diagram 400 according to example embodiments. Referring to FIG. 4, the method may include transmitting authentication credentials to an encryption server at operation 402 and receiving an application session key from the encryption server at operation 404. The method may also include applying the session key to an agent application seeking access to an application server at operation 406, transmitting the session key in an encryption request to the encryption server to obtain an encryption key at operation 408 and receiving an encryption key responsive to the transmitted session key at operation 410. As a result, the user may be able to access the application server with the encryption key provided.

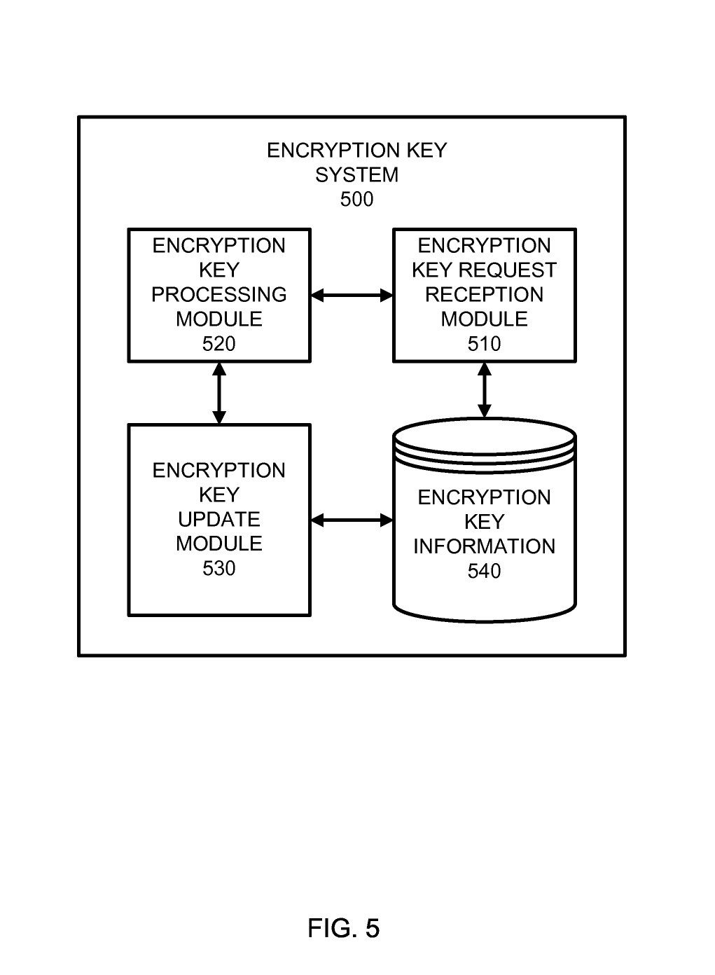

FIG. 5 illustrates an example system 500 configured to perform one or more methods or operations in accordance with the example embodiments. Referring to FIG. 5, the system 500 may include an encryption key request reception module 510 that is used to request and receive an encryption key prior to accessing an application server. In operation, the system may perform transmitting authentication credentials to an encryption server and receiving an application session key from the encryption server via the encryption key reception module 510. User credentials and previous, new or updated session key information may be stored in the encryption key information storage 540. Once the session key is received it may be applied to an agent application seeking access to an application server via the encryption key processing module 520. The encryption key update module 520 may be responsible for transmitting the session key in an encryption request to the encryption server to obtain an encryption key, and receiving an encryption key responsive to the transmitted session key.

In addition to the above-noted operations, the system may also perform establishing a new session, and the application session key may be applied to the new session. The application server may be a storage server, an online application server that provides live session information or any other application server included in a remote network, the cloud, etc. The application session key may include an expiration time period that expires after a predetermined period of time (e.g., 1 minutes, 1 hour, 12 hours, three days, etc.). During the encryption setup process, a request may be transmitted for an application agent installation from a client device for creating an updated encryption key, and responsive to receiving the request the agent application installation information may be received along with an updated encryption key. The method may also provide requesting access to the application server and transmitting the encryption key to the application server and receiving access to the application server.

In operation, the VSA and the agent require may be separate machines or can be the same machine. According to one embodiment, the VSA and the agent are separate machines residing on separate subnets. The VSA requests keys from the encryption server and the keys are kept and managed in the encryption key for all current and subsequent interactions. The VSA and the agent communicate and the session key is sent by the VSA to the agent for the actions taken by the agent. For example, the VSA requests keys from the encryption server and the VSA then sends some or all of those keys to the agent. The agent uses those keys to authenticate and request further keys from the encryption server, the first set of keys may be for authentication to the encryption server while the second set of keys are used to access remote application resources (i.e., storage server in the cloud).

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

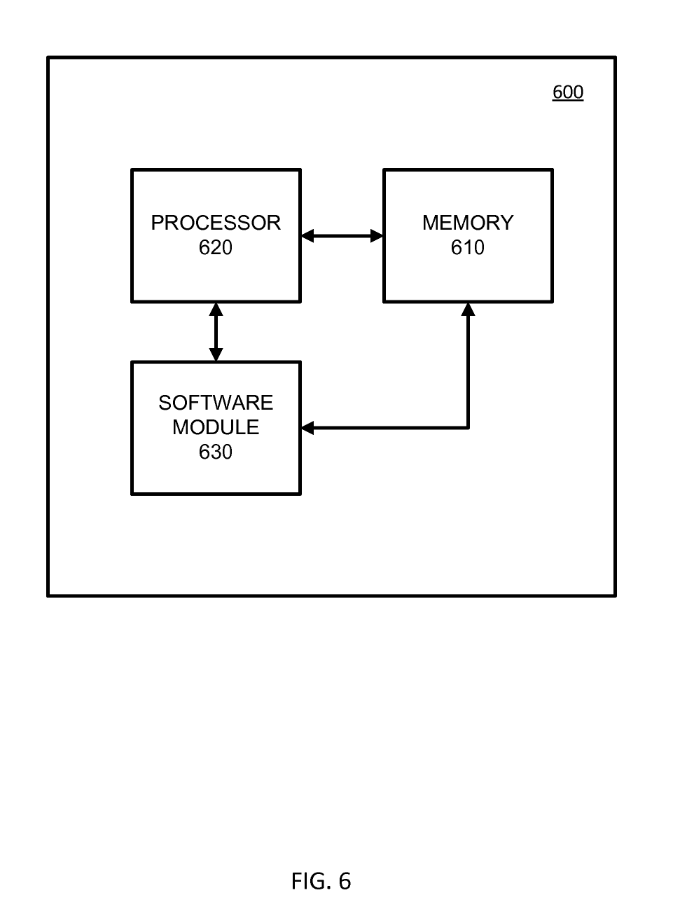

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 6 illustrates an example network element 600, which may represent any of the above-described network components.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

Although an exemplary embodiment of the system, method, and computer readable medium of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the system of FIG. 5 can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
transmitting authentication credentials to an encryption server;
receiving an application session key from the encryption server;
applying the session key to an agent application seeking access to an application server;
transmitting the session key in an encryption request to the encryption server to obtain an encryption key; and
receiving an encryption key responsive to the transmitted session key.

2. The method of claim 1, further comprising:
establishing a new session, and wherein the application session key is applied to the new session.

3. The method of claim 1, wherein the application server is a storage server.

4. The method of claim 1, wherein the application server is an online application server.

5. The method of claim 1, wherein the application session key comprises an expiration time period.

6. The method of claim 1, further comprising:
transmitting a request for an application agent installation from a client device;
creating an updated encryption key responsive to receiving the request;
receiving the agent application installation information; and
receiving the updated encryption key.

7. The method of claim 1, further comprising:
requesting access to the application server;
transmitting the encryption key to the application server; and
receiving access to the application server.

8. An apparatus comprising:
a transmitter configured to transmit authentication credentials to an encryption server;
a receiver configured to receive an application session key from the encryption server;
a processor configured to apply the session key to an agent application seeking access to the application server, and wherein the transmitter is also configured to transmit the session key in an encryption request to the encryption server to obtain an encryption key, and receive an encryption key responsive to the transmitted session key.

9. The apparatus of claim 8, wherein the processor is further configured to establish a new session, and wherein the application session key is applied to the new session.

10. The apparatus of claim 8, wherein the application server is a storage server.

11. The apparatus of claim 8, wherein the application server is an online application server.

12. The apparatus of claim 8, wherein the application session key comprises an expiration time period.

13. The apparatus of claim 8, wherein the transmitter is further configured to transmit a request for an application agent installation from a client device and the processor is further configured to create an updated encryption key responsive to receiving the request, and the receiver is further configured to receive the agent application installation information, and receive the updated encryption key.

14. The apparatus of claim 8, further comprising:
transmitting an access request for access to the application server;
transmitting the encryption key to the application server; and
receiving access to the application server.

15. A non-transitory computer readable storage medium configured to store instructions that when executed cause a processor to perform:
transmitting authentication credentials to an encryption server;
receiving an application session key from the encryption server;
applying the session key to an agent application seeking access to an application server;
transmitting the session key in an encryption request to the encryption server to obtain an encryption key; and
receiving an encryption key responsive to the transmitted session key.

16. The non-transitory computer readable storage medium of claim 15, wherein the processor is further configured to perform:
establishing a new session, and wherein the application session key is applied to the new session.

17. The non-transitory computer readable storage medium of claim 15, wherein the application server is a storage server.

18. The non-transitory computer readable storage medium of claim 15, wherein the application server is an online application server.

19. The non-transitory computer readable storage medium of claim 15, wherein the application session key comprises an expiration time period.

20. The non-transitory computer readable storage medium of claim 15, wherein the processor is further configured to perform:
transmitting a request for an application agent installation from a client device;
creating an updated encryption key responsive to receiving the request;
receiving the agent application installation information;
receiving the updated encryption key;
requesting access to the application server;
transmitting the encryption key to the application server; and
receiving access to the application server.
